(19) United States
(12) Patent Application Publication
(10) Pub. No.: US 2013/0020247 A1
(43) Pub. Date: Jan. 24, 2013

(54) FILTER UNIT FOR AN EXTRUDER SYSTEM AND FILTER ARRANGEMENT AND ASSOCIATED SIEVE CHANGING DEVICE FOR AN EXTRUDER SYSTEM WITH A FILTER UNIT OF THIS TYPE

(71) Applicant: Hans-Joachim SÄMANN, (US)

(72) Inventor: Hans-Joachim SÄMANN, (US)

(21) Appl. No.: 13/552,032

(22) Filed: Jul. 18, 2012

(30) Foreign Application Priority Data
Jul. 21, 2011 (EP) 11 174 785.3

(51) Int. Cl. B01D 36/02

(52) U.S. Cl. 210/232; 210/323.2

(57) ABSTRACT

A filter unit for an extruder system has an outer support body, which is hollow cylindrical and limits an interior. A plurality of outer through-openings open into the interior. An outer filter element is arranged on the support body in the region of the outer through-openings. An inner support body with a plurality of inner through-openings is arranged in the interior. An inner filter element is arranged on the inner support body in the region of the inner through-openings. Using the filter unit according to the invention, a low differential pressure of a plastics material melt to be filtered can be achieved as both the outer filter element and the inner filter element provide a corresponding filter area.

### CROSS-REFERENCES TO RELATED APPLICATIONS

This application claims the priority of European Patent Application, Serial No. 11 174 785.3, pursuant to 35 U.S.C. 119(a)-(d), the content of which is incorporated herein by reference in its entirety as if fully set forth herein.

### FIELD OF THE INVENTION

The invention relates to a filter unit for an extruder system with an outer support body, which is hollow cylindrical and has a centre longitudinal axis and limits an interior and has a plurality of outer through-openings opening therein, and an outer filter element arranged on the outer support body in the region of the outer through-openings. The invention further relates to a filter arrangement and a sieve changing device for an extruder system with a filter unit of this type.

### BACKGROUND OF THE INVENTION

A filter device or filter arrangement with a plurality of filter units called cartridge filters for the uniform filtering of plastics material melts is known from U.S. Pat. No. 4,849,103. The cartridge filters in each case have a support body with through-openings, to which a filter material is applied in the region of the through-openings. The filter material is, for example, a sieve fabric, a sintered metal with pores or a fiber nonwoven. The plastics material melt to be filtered flows through the filter material and the through-openings of the support body into the respective cartridge filter and is thus filtered. The drawback in this filter device and the associated cartridge filters is that they cause a substantial pressure drop or differential pressure of the plastics material melt and the throughput of the plastics material melt through the filter arrangement is thereby limited.

### SUMMARY OF THE INVENTION

The invention is based on an object of developing a filter unit of the generic type in such a way that the differential pressure of the plastics material melt can easily be reduced and the throughput can be correspondingly increased.

This object is achieved by a filter unit having an inner support body with a plurality of inner through-openings is arranged in the interior and an inner filter element is arranged on the inner support body in the region of the inner through-openings. Since an inner support body with a plurality of inner through-openings is arranged in the interior of the outer support body and a further inner filter element is arranged on the inner support body in the region of the inner through-openings, the filter area of the filter unit is easily significantly increased, so the differential pressure of the plastics material melt at the filter unit is reduced in comparison to the prior art. The plastics material melt to be filtered therefore, on the one hand, flows through the outer filter element and the outer through-openings of the outer support body and, on the other hand, through the inner filter element and the inner through-openings of the inner support body. By reducing the differential pressure, higher throughputs through the filter unit and/or longer operating lives of the filter elements can be achieved. Filter elements are generally configured, for example, as sieve fabric or sintered metal bodies with pores. Since the inner support body with the inner filter element is arranged in the interior of the outer support body, the filter unit according to the invention does not have an increased installation space in comparison to the prior art, so the latter can be used in existing filter arrangements and sieve changing devices.

A filter unit, in which the outer support body and the inner support body are arranged concentrically with respect to the centre longitudinal axis, ensures a uniformly reduced differential pressure, as the inner support body is uniformly spaced apart from the outer support body in the radial direction and the filtered plastics material melt can flow into the annular intermediate space formed between the support bodies and flow out again.

A filter unit, in which the inner support body is releasably fastened to the outer support body, ensures a permanently low differential pressure as the support bodies and the filter elements arranged thereon can be easily exchanged in the event of a blockage and/or wear.

A filter unit, in which the inner support body is releasably fastened to a fastening ring, which is releasably fastened to the outer support body, ensures a simple exchange of the support bodies and the filter elements arranged thereon in the event of a blockage and/or wear.

A filter unit, in which the fastening ring in the direction of the centre longitudinal axis forms a stop for the outer filter element, ensures a simple and a secure fastening of the outer filter element.

A filter unit, in which the outer filter element is arranged on a side of the outer support body remote from the inner support body, and the inner filter element is arranged on a side of the inner support body remote from the outer support body, ensures a secure, compact and robust arrangement of the filter elements as these are arranged in front of the respective associated support body in the flow direction of the plastics material melt.

A filter unit, in which the inner support body has at least one hollow cylindrical wall portion and a base portion connected thereto, and the at least one wall portion opposite the base portion forms an inlet opening, ensures a low differential pressure as the plastics material melt can flow unhindered through the inlet opening into the interior limited by the inner support body and can flow from there through the inner filter element.

A filter unit, in which the inner through-openings are formed in the wall portion and the base portion, allows a large filter area of the inner filter element.

A filter unit, in which the inner filter element is pot-like, ensures a low differential pressure of the plastics material melt as the inner filter element has a large filter area because of the pot-like configuration. Moreover, a low differential pressure of the plastics material melt is achieved as the plastics material melt can flow unhindered in the axial direction through the inner filter element.

A filter unit, in which for a radial spacing a between the inner support body and the outer support body based on a radial spacing A of the outer support body from the centre longitudinal axis there applies 0.2≦a/A≦0.8, in particular 0.3≦a/A≦0.7 and in particular 0.4≦a/A≦0.6, ensures a low differential pressure of the plastics material melt as the diameter or radius of the inner support element, on the one hand, allows a large filter area of the inner filter element but, on the other hand, the radial spacing between the support bodies is still large enough for the filtered plastics material melt to be able to flow out well from the intermediate space between the support bodies.

A filter unit, in which the outer through-openings in the direction of the centre longitudinal axis define an outer filter length F_{A} and the inner through-openings in the direction of the centre longitudinal axis define an inner filter length F_{I}, wherein there applies F_{I}/F_{A}≧0.5, in particular F_{I}/F_{A}≧0.6 and in particular F_{I}/F_{A}≧0.7, allows an optimization of the differential pressure of the plastics material melt as the filter area of the inner filter element can be increased with an increasing inner filter length.

A filter unit, in which the outer through-openings in the direction of the centre longitudinal axis define an outer filter length F_{A} and the inner through-openings in the direction of the centre longitudinal axis define an inner filter length F_{I}, wherein there applies F_{I}/F_{A}≦1.0, in particular F_{I}/F_{A}≦0.9 and in particular F_{I}/F_{A}≦0.8, allows an optimization of the differential pressure of the plastics material melt as, on the one hand, a large inner filter length can be achieved but, on the other hand, the filtered plastics material melt can flow out well from the intermediate space between the support bodies.

A filter unit, in which the base portion is arranged in the region of the outer through-openings in the interior, allows a low differential pressure of the plastics material melt as the filtered plastics material melt can flow out well from the interior of the outer support body and can flow through the carrier through-openings of a filter carrier.

A filter unit, in which the inner support body is screwed by an external thread into an internal thread of the fastening ring, allows the plastics material melt to flow unhindered through the inlet opening into the interior of the inner support body.

A filter unit, in which the outer support body has an internal thread, on which the fastening ring is releasably fastened by means of an associated external thread, allows an optimization of the differential pressure of the plastics material melt as the outer filter length is optimized.

A filter arrangement for an extruder system with a filter carrier, which has a carrier centre longitudinal axis and a plurality of carrier through-openings running in the direction of the carrier centre longitudinal axis, in which a filter unit according to the invention is in each case releasably fastened to the filter carrier in the region of the carrier through-openings, ensures a low differential pressure of the plastics material melt as a large number of the filter units according to the invention can be used to filter the plastics material melt. Existing filter arrangements according to the prior art can be retrofitted with the filter units according to the invention owing to the releasable arrangement of the filter units according to the invention on the filter carrier. Furthermore, blocked and/or worn filter units can easily be exchanged and cleaned.

A filter unit, in which a first carrier through-opening is arranged concentrically with respect to the carrier centre longitudinal axis, at least six second carrier through-openings are arranged along a first circle, which is arranged concentrically with respect to the carrier centre longitudinal axis, and at least twelve third carrier through-openings are arranged along a second circle, which is arranged concentrically with respect to the carrier centre longitudinal axis and surrounds the first circle, is an optimal arrangement of the filter units in relation to the total filter area to be achieved and the differential pressure resulting from this of the plastics material melt.

A sieve changing device with a housing, a melt channel running in the housing, a guide bore running transverse to the melt channel and through the latter in the housing, a slide element arranged in the guide bore, and two filter arrangements mounted spaced apart on the slide element, each filter arrangement having a filter carrier with a carrier centre longitudinal axis and a plurality of carrier through-openings running in the direction of the carrier centre longitudinal axis, in which a filter unit (35) according to the invention is releasably fastened in each case to the associated filter carrier in the region of the carrier through-openings, allows the filtering of plastics material melts in an extruder system with a permanently low differential pressure of the plastics material melt. As a result, the throughput of the plastics material melt through the extruder system can be optimized. When maintenance of one of the filter arrangements is necessary, the filtering of the plastics material melt can be continued without an interruption in that the slide element is displaced in a conventional manner in such a way that the maintained second filter arrangement is used.

Further features, advantages and details of the invention emerge from the following description of an embodiment.

### BRIEF DESCRIPTION OF THE DRAWINGS

FIG. 1 shows a schematic view of an extruder system with an extruder and a downstream sieve changing device for filtering plastics material melts,

FIG. 2 shows a cross section through the extruder shown in FIG. 1,

FIG. 3 shows a perspective view of the sieve changing device in FIG. 1,

FIG. 4 shows a partially sectional view of the sieve changing device in FIG. 3 with two spaced-apart filter arrangements and filter units arranged thereon,

FIG. 5 shows a schematic axial plan view of one of the filter arrangements in FIG. 4,

FIG. 6 shows a first perspective view of a filter unit in FIG. 4 without associated filter elements,

FIG. 7 shows a second perspective view of the filter unit in FIGS. 6, and

FIG. 8 shows an axial section through the filter unit in FIG. 6 including the associated filter elements.

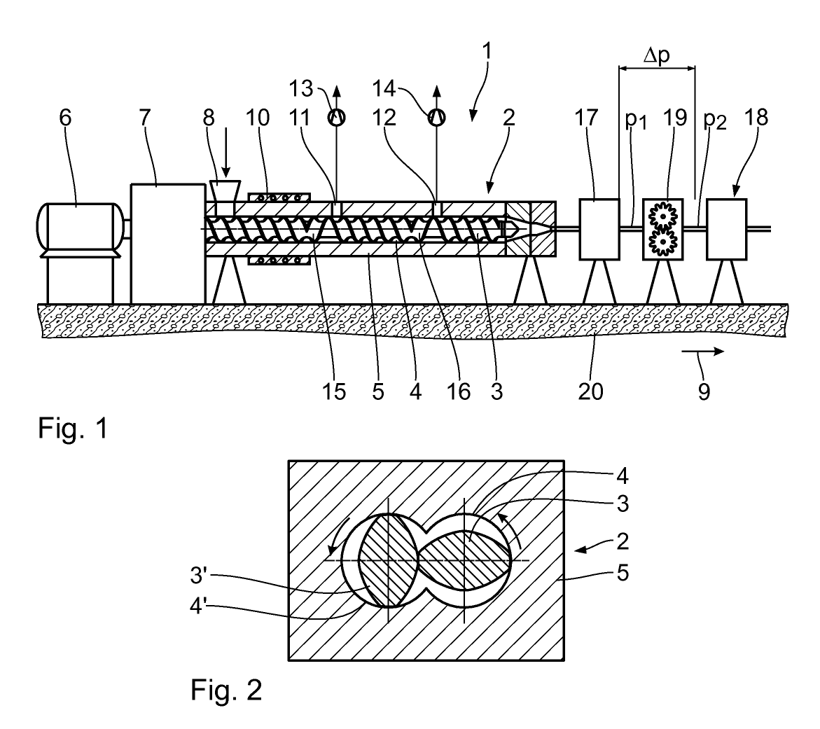

### DESCRIPTION OF THE PREFERRED EMBODIMENT

To process plastics material, an extruder system 1 has a two-shaft extruder 2, which is configured in the conventional manner. The extruder 2 has two worm shafts 3, 3′. These are arranged in corresponding bores 4, 4′ of a housing 5. The worm shafts 3, 3′ are configured to be closely meshing and rotating in the same direction. The worm shafts 3, 3′ are driven by an electric motor 6 by a reduction and distribution gear unit 7, on which the housing 5 is flanged.

Adjacent to the gear unit 7, in other words at the upstream end of the extruder 2, a feed funnel 8 opens into the housing 5. The housing 5 is provided with a heater 10 in a conveying direction 9 after the funnel 8. Provided following this consecutively in the conveying direction 9 are two degassing openings 11, 12 opening out of the housing 5, which are in each case connected to a vacuum pump 13, 14. Provided in front of, in other words upstream of each degassing opening 11, 12 in the conveying direction 9 on the worm shafts 3, 3′ are damming mechanisms 15, 16 in the form of worm portions conveying counter to the conveying direction 9.

The extruder 1 opens at its end downstream in the conveying direction 9 into a start-up valve 17, downstream of which a toothed wheel pump 19 is arranged in the conveying direction 9. The toothed wheel pump 19 opens into a sieve changing device 18. The described components are arranged on a base 20.

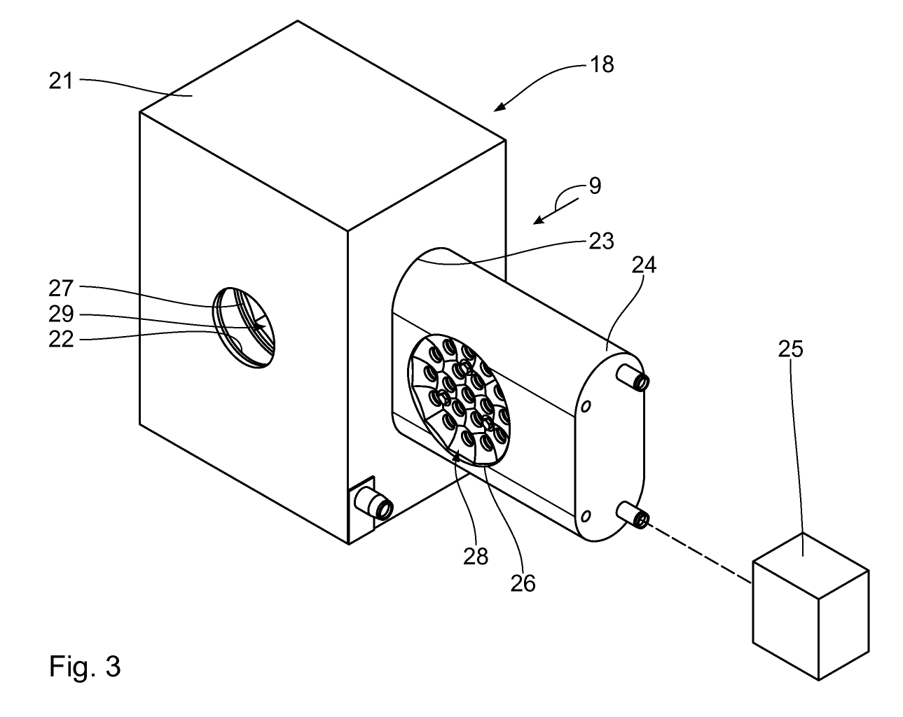

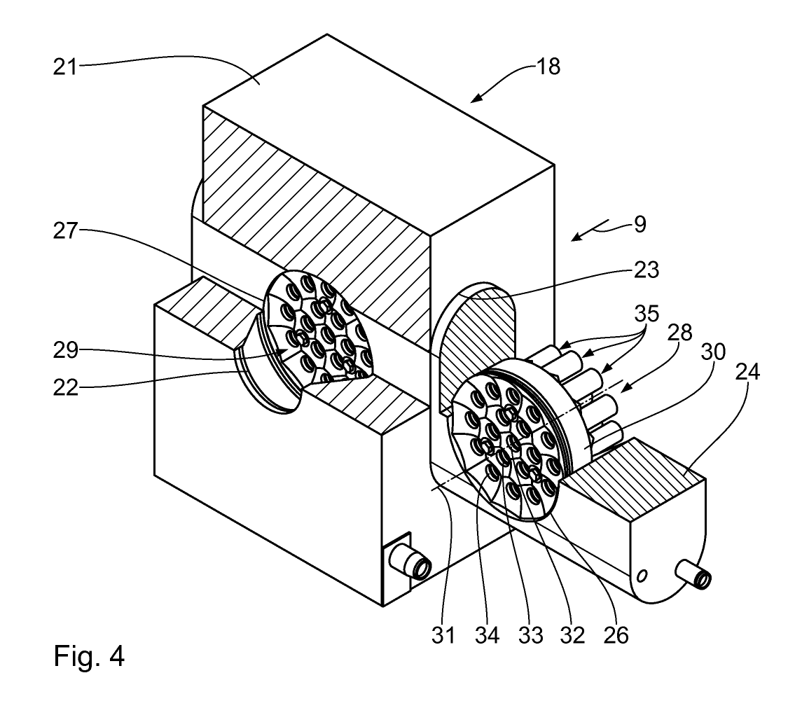

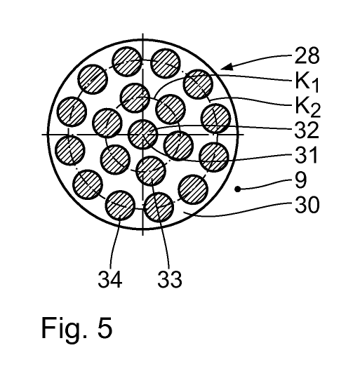

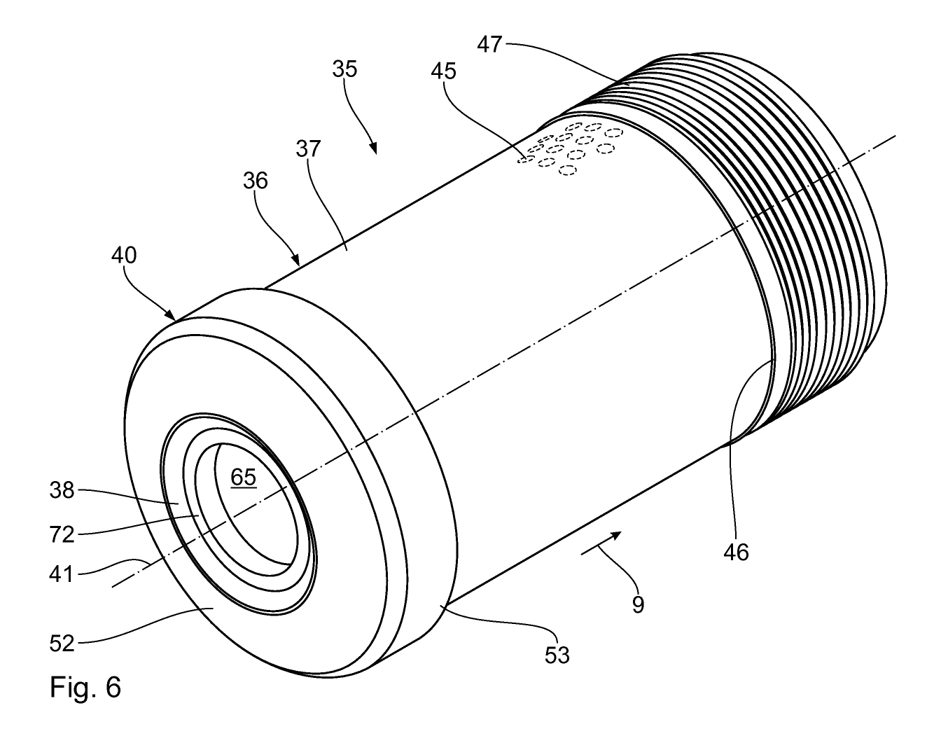

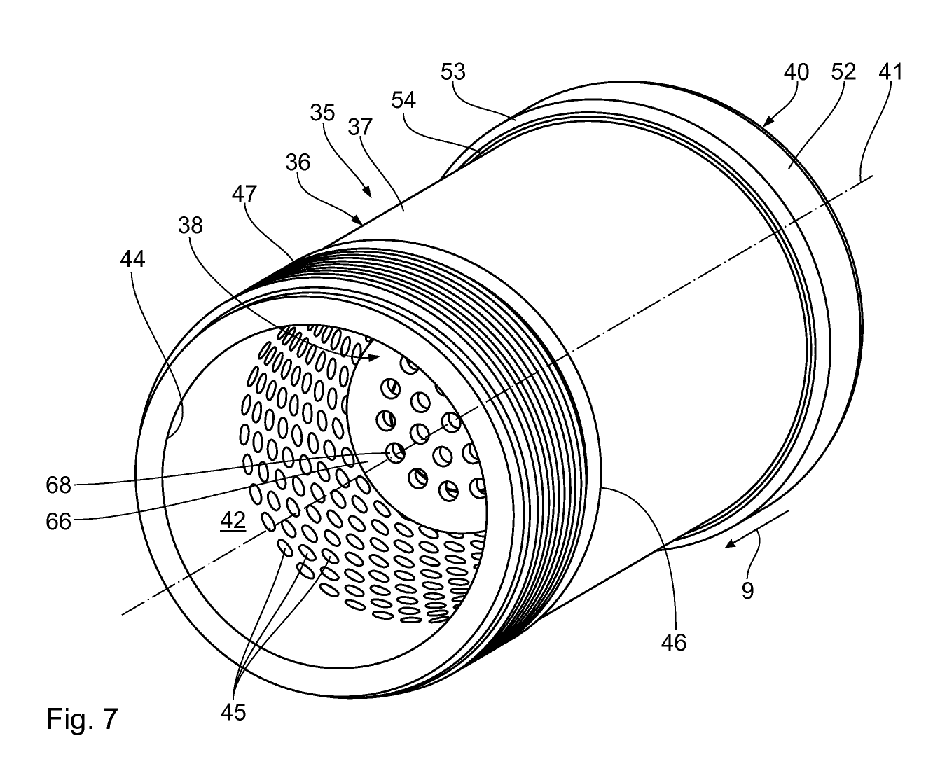

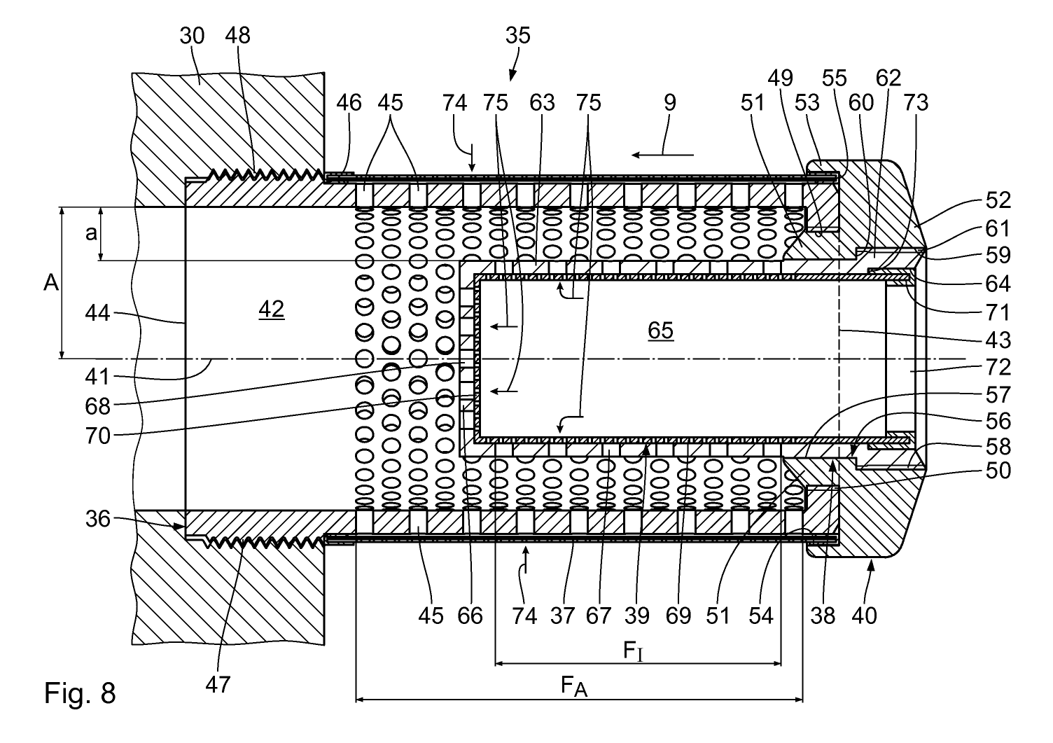

The sieve changing device 18 has a housing 21, in which a melt channel 22 running in the conveying direction 9 for the plastics material melt produced in the extruder 2 is formed. Furthermore, a guide bore 23 running transverse to the conveying direction 9 and crossing the melt channel 22 is formed in the housing 21. A plate-like slide element 24, which can be displaced by means of an actuating drive 25 transverse to the conveying direction 9, is arranged in the guide bore 23. The actuating drive 25 is, for example, hydraulic or electromechanical and only indicated in FIG. 3. Two continuous receiving openings 26, 27, in which a filter arrangement 28, 29 is mounted in each case, are configured in the slide element 24. The receiving openings 26, 27 are spaced apart transverse to the conveying direction 9 in such a way that one of the filter arrangements 28, 29 is in each case located outside the housing 21 when the respective other filter arrangement 28, 29 is located in the melt channel 22.

The filter arrangements 28, 29 are configured identically, so only the filter arrangement 28 is described in detail below. The filter arrangement 28 has a cross sectionally circular filter carrier 30 with a carrier centre longitudinal axis 31 running in the conveying direction 9. A plurality of carrier through-openings 32, 33, 34 running in the direction of the carrier centre longitudinal axis 31 are formed in the filter carrier 30. A first carrier through-opening 32 is arranged concentrically with respect to the carrier centre longitudinal axis 31. A group of six second carrier through-openings 33 is arranged along a first circle K₁, which is in turn arranged concentrically with respect to the carrier centre longitudinal axis 31. The second carrier through-openings 33 are distributed uniformly along the circle K₁. A further group of twelve third carrier through-openings 34 is arranged along a second circle K₂, which is arranged concentrically with respect to the carrier centre longitudinal axis 31 and surrounds the first circle K₁. The third carrier through-openings 34 are distributed uniformly along the circle K₂.

A filter unit 35 is in each case releasably fastened to the filter carrier 30 in the region of the carrier through-openings 32, 33, 34. The filter units 35 are arranged before the filter carrier 30 in the conveying direction 9.

The filter units 35 are configured identically so only one filter unit 35 is described in detail below. The filter unit 35 comprises an outer support body 36 with an associated outer filter element 37 and an inner support body 38 with an associated inner filter element 39 and a fastening ring 40 to connect the support bodies 36, 38. The outer support body 36 is hollow cylindrical and has a centre longitudinal axis 41, which runs in the direction of the conveying direction 9. The outer support body 36 limits an interior 42, into which a first opening 43 opens at an upstream side of the support body 36 and a second opening 44 opens at a downstream side of the support body 36. Furthermore, a large number of outer through-openings 45 formed in the outer support body 36 open into the interior 42, said through-openings running in the radial direction relative to the centre longitudinal axis 41 and being distributed uniformly over the periphery of the outer support body 36.

The outer filter element 37 is also hollow cylindrical and rests on a side remote from the inner support body 38 in the region of the outer through-openings 45 on the outer support body 36. At the downstream side, the outer support body 36 forms a first stop 46 for the outer filter element 37, so the latter can easily be pushed onto the outer support body 36 up to the first stop 46. At the downstream side, the outer support body 36 furthermore has an external thread 47, which is arranged downstream of the stop 46 in the conveying direction 9. The outer support body 36 is screwed by the external thread 47 into an associated internal thread 48, which is formed in the region of one of the carrier through-openings 32, 33, 34 in the filter carrier 30. The filter unit 35 is thus releasably arranged on the filter carrier 30.

The inner support body 38 is substantially partially arranged in the interior 42 by means of the fastening ring 40. For this purpose, the outer support body 36 has an internal thread 49 on the upstream side in the region of the first opening 43. The fastening ring 40 is releasably fastened to this internal thread 49 by means of an associated external thread 50. The external thread 50 is formed on a first annular portion 51 of the fastening ring 40, which in the fastened state extends through the first opening 43 into the interior 42. A second portion 52 with a larger diameter, which in the screwed-in state of the fastening ring 40 rests on the end face against the outer support body 36, adjoins the first portion 51. The second portion 52 projects in the radial direction over the outer support body 36 and has an annular projection 53 running in the direction of the centre longitudinal axis 41, so an annular space 54, into which the outer filter element 37 extends, is formed between the projection 53 and the outer support body 36. The second portion 52 forms a second stop 55 for the outer filter element 37 in the axial direction.

The inner support body 38 is releasably fastened to the fastening ring 40 or the outer support body 36. For this purpose, a through-bore 56, which is stepped in diameter and has a first bore portion 57 and a second bore portion 58, which is larger in diameter, is formed in the fastening ring 40. In the region of the bore portion 58, the fastening ring 40 has an internal thread 59 extending up to a third stop 60. The inner support body 38 is screwed by an external thread 61 into the internal thread 59 and therefore releasably connected to the fastening ring 40.

The inner support body 38 has a hollow cylindrical first wall portion 62 and a hollow cylindrical second wall portion 63 arranged thereon, which has a smaller internal and external diameter in comparison to the first wall portion 62. The first wall portion 62 is arranged on an upstream side of the inner support element 38 and, on its outside, has the external thread 61. The first wall portion 62, in the fastened state of the support body 38, rests on the stop 60. Furthermore, the first wall portion 62 on the upstream side of the inner support body 38 forms an inlet opening 64, through which plastics material melt can flow into an interior 65 limited by the inner support body 38. Opposite the inlet opening 64, in other words on the downstream side of the inner support body 38, the latter has a base portion 66, which runs transverse to the centre longitudinal axis 41 and is connected to the second wall portion 63.

The inner support body 38 is arranged concentrically with respect to the centre longitudinal axis 41 and extends with the second wall portion 63 and the base portion 66 into the interior 42 of the outer support body 38. A large number of inner through-openings 67, 68 are formed in the second wall portion 63 and the base portion 66. The through-openings 67 formed in the second wall portion 63 run radially with respect to the centre longitudinal axis 41, whereas the through-openings 68 formed in the base portion 66 run parallel to the centre longitudinal axis 41.

The inner filter element 39 is formed as a filter insert and has a pot-like shape. The inner filter element 39, in accordance with the inner support body 38, has a hollow cylindrical filter wall portion 69 and a filter base portion 70, which are connected to one another at a downstream side of the inner filter element 39. At the end of the filter element 39 opposing the filter base portion 70, the latter forms a filter inlet opening 71. The filter wall portion 69 is reinforced in the region of the filter inlet opening 71 by a reinforcing ring 72 that has been placed on. In the inserted state, the inner filter element 39 rests against the inner support body 38, the reinforcing ring 72 resting against a stop 73 of the inner support body 38 formed by the wall portion 63. The inner filter element 39 is therefore arranged on a side of the inner support body 38 remote from the outer support body 36. The inner filter element 39 therefore rests on the inner support body 38 in the region of the inner through-openings 67, 68.

The filter elements 37, 39 are configured in a conventional manner, for example as a sieve fabric or sintered metal body with pores. The filter elements 37, 39, depending on the plastics material melt to be filtered, may have a specific sieve mesh size or pore size.

The inner support body 38 has a spacing a from the outer support body 36 in the radial direction, to which there applies, based on a radial spacing A of the outer support body 36 from the centre longitudinal axis 41: 0.2≦a/A≦0.8, in particular 0.3≦a/A≦0.7 and in particular 0.4≦a/A≦0.6.

Furthermore, the outer through-openings 45 in the direction of the centre longitudinal axis 41 define an outer filter length F_{A} and the inner through-openings 67 in a corresponding manner define an inner filter length F_{I}, wherein there applies: F_{I}/F_{A}≧0.5, in particular F_{I}/F_{A}≧0.6 and in particular F_{I}/F_{A}≧0.7. Furthermore there applies: F_{I}/F_{A}≦1.0, in particular F_{I}/F_{A}≦0.9 and in particular F_{I}/F_{A}≦0.8. The base portion 66 is in particular arranged in the region of the outer through-openings 45 in the interior 42.

The plastics material to be processed is introduced through the funnel 8 into the extruder 2 and melted there. The plastics material melt leaving the extruder 2 flows through the start-up valve 17 and is conveyed further by means of the toothed wheel pump 19 and then arrives in the sieve changing device 18, where impurities in the plastics material melt are filtered out.

In the sieve changing device 18, the plastics material melt flows through the filter arrangement 28 or 29 located in the melt channel 22. The plastics material melt at each filter unit 35 thus, on the one hand, passes in a first melt flow direction 74 through the outer filter element 37 and the through-openings 45 of the outer support body 36 into the interior 42 and is thus filtered. On the other hand, the plastics material melt passes through the filter inlet opening 71 into the interior 65 and from there flows in second melt flow directions 75 through the inner filter element 39 and the through-openings 67, 68 of the inner support body 38 and is thus filtered. Since both the outer filter element 37 and the inner filter element 39 provide a filter area, the filter arrangement 28 or 29 merely causes a comparatively low differential pressure Δp=p₁−p₂ of the plastics material melt. p₁ is the pressure of the plastics material melt before the filter arrangement 28, 29 here and p₂ is the pressure of the plastics material melt after the filter arrangement 28 or 29. Furthermore, the filter arrangement 28 or 29 therefore causes a comparatively low differential pressure Δp, as the plastics material melt flows through the filter inlet opening 71 into the interior 65 and flows from there, on the one hand, in the radial melt flow direction 75 through the filter wall portion 69 and in the axial melt flow direction 75 through the filter base portion 70 of the inner filter element 39 and the inner support body 38, so a low flow resistance is achieved. The inner support body 38, for this purpose, has a diameter in relation to the outer support body 36 such that, on the one hand, the filter area of the inner filter element 39 is adequately large and, on the other hand, the intermediate space formed between the support bodies 36, 38 is not so small that an outflow of the plastics material melt is impaired. Consequently, the stress on the plastics material melt can be reduced and/or higher throughputs can be achieved. Owing to the lower differential pressure, the operating lives of the filter elements 37, 39 can furthermore be extended.

Since the filter units 35 can be completely disassembled, the filter units 35 can be maintained in a simple manner. The operation of the extruder system 1 thus does not need to be interrupted as when maintenance of one of the filter arrangements 28, 29 is necessary, the respective other filter arrangement 28, 29 can be brought into use by means of the sieve changing device 18, so the filter arrangement 28, 29 to be maintained is available for maintenance.

What is claimed is:

1. A filter unit for an extruder system with
an outer support body (36), which
is hollow cylindrical and has a centre longitudinal axis (41),
limits an interior (42) and has a plurality of outer through-openings (45) opening therein,
an outer filter element (37) arranged on the outer support body (36) in the region of the outer through-openings (45),
wherein
an inner support body (38) with a plurality of inner through-openings (67, 68) is arranged in the interior (42) and
an inner filter element (39) is arranged on the inner support body (38) in the region of the inner through-openings (67, 68).

2. A filter unit according to claim 1, wherein
the outer support body (36) and the inner support body (38) are arranged concentrically with respect to the centre longitudinal axis (41).

3. A filter unit according to claim 1, wherein
the inner support body (38) is releasably fastened to the outer support body (36).

4. A filter unit according claim 1, wherein
the inner support body (38) is releasably fastened to a fastening ring (40), which is releasably fastened to the outer support body (36).

5. A filter unit according to claim 4, wherein
the fastening ring (40) in the direction of the centre longitudinal axis (41) forms a stop (55) for the outer filter element (37).

6. A filter unit according to claim 1, wherein
the outer filter element (37) is arranged on a side of the outer support body (36) remote from the inner support body (38), and
the inner filter element (39) is arranged on a side of the inner support body (38) remote from the outer support body (36).

7. A filter unit according to claim 1, wherein
the inner support body (38) has at least one hollow cylindrical wall portion (62, 63) and a base portion (66) connected thereto, and
the at least one wall portion (62, 63) opposite the base portion (66) forms an inlet opening (64).

8. A filter unit according to claim 7, wherein
the inner through-openings (67, 68) are formed in the wall portion (63) and the base portion (66).

9. A filter unit according to claim 1, wherein
the inner filter element (39) is pot-like.

10. A filter unit according to claim 1, wherein
for a radial spacing a between the inner support body (38) and the outer support body (36) based on a radial spacing A of the outer support body (36) from the centre longitudinal axis (41) there applies: 0.2≦a/A≦0.8.

11. A filter unit according to claim 1, wherein
for a radial spacing a between the inner support body (38) and the outer support body (36) based on a radial spacing A of the outer support body (36) from the centre longitudinal axis (41) there applies: 0.3≦a/A≦0.7.

12. A filter unit according to claim 1, wherein
for a radial spacing a between the inner support body (38) and the outer support body (36) based on a radial spacing A of the outer support body (36) from the centre longitudinal axis (41) there applies: 0.4≦a/A≦0.6.

13. A filter unit according to claim 1, wherein
the outer through-openings (45) in the direction of the centre longitudinal axis (41) define an outer filter length F_{A} and the inner through-openings (67) in the direction of the centre longitudinal axis (41) define an inner filter length F_{I}, wherein there applies: F_{I}/F_{A}≧0.5.

14. A filter unit according to claim 1, wherein
the outer through-openings (45) in the direction of the centre longitudinal axis (41) define an outer filter length F_{A} and the inner through-openings (67) in the direction of the centre longitudinal axis (41) define an inner filter length F_{I}, wherein there applies: F_{I}/F_{A}≧0.6.

15. A filter unit according to claim 1, wherein
the outer through-openings (45) in the direction of the centre longitudinal axis (41) define an outer filter length F_{A} and the inner through-openings (67) in the direction of the centre longitudinal axis (41) define an inner filter length F_{I}, wherein there applies: F_{I}/F_{A}≧0.7.

16. A filter unit according to claim 1, wherein
the outer through-openings (45) in the direction of the centre longitudinal axis (41) define an outer filter length F_{A} and the inner through-openings (67) in the direction of the centre longitudinal axis (41) define an inner filter length F_{I}, wherein there applies: F_{I}/F_{A}≦1.0.

17. A filter unit according to claim 1, wherein
the outer through-openings (45) in the direction of the centre longitudinal axis (41) define an outer filter length F_{A} and the inner through-openings (67) in the direction of the centre longitudinal axis (41) define an inner filter length F_{I}, wherein there applies: F_{I}/F_{A}≦0.9.

18. A filter unit according to claim 1, wherein
the outer through-openings (45) in the direction of the centre longitudinal axis (41) define an outer filter length F_{A} and the inner through-openings (67) in the direction of the centre longitudinal axis (41) define an inner filter length F_{I}, wherein there applies: F_{I}/F_{A}≦0.8.

19. A filter unit according to claim 7, wherein
the base portion (66) is arranged in the region of the outer through-openings (45) in the interior (42).

20. A filter unit according to claim 4, wherein
the inner support body (38) is screwed by an external thread (61) into an internal thread (59) of the fastening ring (40).

21. A filter unit according to claim 4, wherein
the outer support body (36) has an internal thread (49), on which the fastening ring (40) is releasably fastened by means of an associated external thread (50).

22. A filter arrangement for an extruder system with
a filter carrier (30), which has a carrier centre longitudinal axis (31) and a plurality of carrier through-openings (32, 33, 34) running in the direction of the carrier centre longitudinal axis (31),
wherein
a filter unit (35) with
an outer support body (36), which
is hollow cylindrical and has a centre longitudinal axis (41),
limits an interior (42) and has a plurality of outer through-openings (45) opening therein,
an outer filter element (37) arranged on the outer support body (36) in the region of the outer through-openings (45),
wherein an inner support body (38) with a plurality of inner through-openings (67, 68) is arranged in the interior (42) and
wherein an inner filter element (39) is arranged on the inner support body (38) in the region of the inner through-openings (67, 68),
is in each case releasably fastened to the filter carrier (30) in the region of the carrier through-openings (32, 33, 34).

23. A filter arrangement according to claim 22, wherein
a first carrier through-opening (32) is arranged concentrically with respect to the carrier centre longitudinal axis (31),
at least six second carrier through-openings (33) are arranged along a first circle (K₁), which is arranged concentrically with respect to the carrier centre longitudinal axis (31), and
at least twelve third carrier through-openings (34) are arranged along a second circle (K₂), which is arranged concentrically with respect to the carrier centre longitudinal axis (31) and surrounds the first circle (K₁).

24. A sieve changing device for an extruder system with
a housing (21),
a melt channel (22) running in the housing (21),
a guide bore (23) running transverse to the melt channel (22) and through the latter in the housing (21),
a slide element (24) arranged in the guide bore (23),
two filter arrangements (28, 29) mounted spaced apart on the slide element (24), each filter arrangement (28, 29) having a filter carrier (30) with a carrier centre longitudinal axis (31) and a plurality of carrier through-openings (32, 33, 34) running in the direction of the carrier centre longitudinal axis (31),
wherein
a filter unit (35) with
an outer support body (36), which
is hollow cylindrical and has a centre longitudinal axis (41),
limits an interior (42) and has a plurality of outer through-openings (45) opening therein,
an outer filter element (37) arranged on the outer support body (36) in the region of the outer through-openings (45),
wherein an inner support body (38) with a plurality of inner through-openings (67, 68) is arranged in the interior (42) and
wherein an inner filter element (39) is arranged on the inner support body (38) in the region of the inner through-openings (67, 68),
is releasably fastened in each case to the associated filter carrier (30) in the region of the carrier through-openings (32, 33, 34).
